(19) United States
(12) Patent Application Publication
(10) Pub. No.: US 2018/0165931 A1
(43) Pub. Date: Jun. 14, 2018

(54) ROBOT SECURITY INSPECTION METHOD BASED ON ENVIRONMENT MAP AND ROBOT THEREOF

(71) Applicant: Nanjing AvatarMind Robot Technology Co., Ltd., Nanjing (CN)

(72) Inventor: Fan ZHANG, Nanjing (CN)

(21) Appl. No.: 15/870,857

(22) Filed: Jan. 13, 2018

Related U.S. Application Data
(63) Continuation of application No. PCT/CN2017/108725, filed on Oct. 31, 2017.

(30) Foreign Application Priority Data
Dec. 14, 2016 (CN) 201611154363.6

(51) Int. Cl. G08B 13/196; G08B 19/00; G06K 9/00; B25J 5/00; B25J 9/16; B25J 11/00

(52) U.S. Cl. CPC G08B 13/19621; G08B 19/00; G06K 9/00771; B25J 11/002; B25J 5/007; B25J 9/1697; B25J 9/1679; G06K 9/00369

(57) ABSTRACT

The present disclosure provides a robot security inspection method based on an environment map and a robot thereof. The method includes: establishing a two-dimensional planar map of an entire monitored region, planning a monitoring route, determining the position of the robot at the current monitored region, and moving to perform inspection according to the planed monitoring route. With the robot security inspection method based on an environment map and the robot thereof according to the present disclosure, traversing-based inspection may be performed according to the environment map, thereby preventing the dead space in the monitoring; dangerous factors may be proactively detected and security policy conformation may be conducted; the dangerous factors may be proactively tracked; and the robot is capable of normally operating even without auxiliary illumination at night.

### CROSS-REFERENCE TO RELATED APPLICATIONS

This application is a continuation application of international patent application No. PCT/CN2017/108725, filed on Oct. 31, 2017, which is based upon and claims priority of Chinese Patent Application No. 201611154363.6, filed before Chinese Patent Office on Dec. 14, 2016 and entitled “ROBOT SECURITY INSPECTION METHOD BASED ON ENVIRONMENT MAP AND ROBOT THEREOF”, the entire contents of which are incorporated herein by reference.

### TECHNICAL FIELD

The present disclosure relates to the technical field of security monitoring, and in particular, relates to a robot security inspection method based on an environment map and a robot thereof.

### BACKGROUND

At present, the passive video monitoring method is mostly used in the security monitoring field. Generally, a camera is mounted at a specific monitoring spot, images at the monitoring spots are displayed in a centralized manner in a specific region, and insecure factors are checked by manual reviewing images photographed by all the cameras. This method has many defects: 1) the monitored images need to be manually checked constantly, and thus visual fatigue may cause misjudgment of the insecure factors. 2) The visual angle of the camera is relatively fixed and large-range movements may not be implemented; if a large-scale scenario needs to be monitored, a lot of cameras need to be deployed, and monitoring dead space is may be caused. 3) In case of detecting insecure factors, active tracking may not be practiced in the video monitoring mode. 4) The monitoring cameras are mostly RGB cameras and do not have the night vision function, and thus night monitoring capabilities are greatly lowered, and auxiliary illumination is generally needed, thereby causing many adverse impacts.

### SUMMARY

The technical problem to be solved by the present disclosure is to provide a robot security inspection method based on an environment map and a robot thereof. With the method and the robot, active uninterrupted monitoring is implemented, and active tracking of insecure is practiced.

To achieve the above objectives, the present disclosure provides a robot security inspection method based on an environment map. The method includes: S3: in a course where a robot inspects a monitored region according to a monitoring route, acquiring current depth data if a predetermined photographing time interval is reached; S4: determining, according to the current depth data, current odometer information and a two-dimensional planar map of the monitored region, a current position of the robot in the two-dimensional planar map, and judging whether an abnormal factor is present at the current position; S5: performing a corresponding operation according to the abnormal factor if the abnormal factor is present; or S6: continuing to inspect the monitored region according to the monitoring route if the abnormal factor is not present.

Further, prior to step S3, the method further includes: S1: upon receipt of a map establishment instruction, traversing, by the robot, the monitored region, and establishing the two-dimensional planar map of the monitored region according to depth data of each obstacle in the monitored region and odometer information corresponding to the depth data acquired during the traversing; and S2: planning the monitoring route according to an inspection starting point, an inspection endpoint and the two-dimensional planar map.

Further, step S1 specifically includes the following steps: S11: upon receipt of the map establishment instruction, traversing, by the robot, the monitored region, and acquiring the depth data of each obstacle in the monitored region during the traversing; S12: projecting the depth data within a predetermined height range onto a predetermined horizontal plane to obtain corresponding two-dimensional laser radar data; and S13: establishing the two-dimensional planar map of the monitored region according to the laser radar data and odometer information corresponding to the laser radar data.

Further, step S4 of determining, according to the current depth data, current odometer information and a two-dimensional planar map of the monitored region, a current position of the robot in the two-dimensional planar map, and judging whether an abnormal factor is present at the current position includes the following steps: S41: judging whether there is an obstacle not marked in the two-dimensional planar map, considering that the abnormal factor is present if there is an obstacle not marked in the two-dimensional planar map, or considering that the abnormal factor is not present if there is no obstacle not marked in the two-dimensional planar map; and step S5 includes the following steps: S510: if there is an obstacle not marked, marking the obstacle not marked in the two-dimensional planar map according to the current depth data and the current odometer information, and updating the two-dimensional planar map; and S511: updating the monitoring route according to the current position and the updated two-dimensional planar map, and inspecting the monitored region according to the updated monitoring route.

Further, step S4 of determining, according to the current depth data, current odometer information and a two-dimensional planar map of the monitored region, a current position of the robot in the two-dimensional planar map, and judging whether an abnormal factor is present at the current position includes the following steps: S42: judging whether human skeleton data is identified, considering that the abnormal factor is present if the human skeleton data is identified, or considering that the abnormal factor is not present if the human skeleton data is not identified; and step S5 includes the following steps: S520: moving towards a living body corresponding to the human skeleton data if the human skeleton data is identified; S521: acquiring a current facial feature of the living body; S522: matching the current facial feature with a predetermined facial feature in a predetermined living body facial feature database if the current facial feature of the living body is successfully acquired; S523: considering that the abnormal factor is not present if the matching is successful; and S524: performing a tracking operation for the living body and generating alarm information if the matching is unsuccessful.

Further, following step S521, the method further includes: S525: acquiring password information from the living body if the current facial feature of the living body is not successfully acquired; S526: matching the acquired password information with predetermined password information in a predetermined password database; S523: considering that the abnormal factor is not present if the matching is successful; and S524: performing the tracking operation for the living body and generating the alarm information if the matching is unsuccessful.

Further, the method further includes: S7: in the course where the robot inspects the monitored region according to the monitoring route, acquiring a current smoke concentration value if a predetermined detection time interval is reached; S8: judging whether the current smoke concentration value exceeds a predetermined smoke concentration threshold; S9: generating alarm information if the current smoke concentration value exceeds the predetermined smoke concentration threshold; or S10: continuing to inspect the monitored region according to the monitoring route if the smoke concentration value does not exceed the predetermined smoke concentration threshold.

The present disclosure further provides a robot. The robot includes: a data acquiring module, configured to: in a course where a robot inspects a monitored region according to a monitoring route, acquire current depth data if a predetermined photographing time interval is reached; a judging module, configured to: determine, according to the current depth data, current odometer information and a two-dimensional planar map of the monitored region, a current position of the robot in the two-dimensional planar map, and judge whether an abnormal factor is present at the current position; and an executing module, configured to: perform a corresponding operation according to the abnormal factor if the abnormal factor is present, or continue to inspect the monitored region according to the monitoring route if the abnormal factor is not present.

Further, the executing module includes: a map establishing submodule, configured to, upon receipt of a map establishment instruction, traverse the monitored region, and establish the two-dimensional planar map of the monitored region according to depth data of each obstacle in the monitored region and odometer information corresponding to the depth data acquired during the traversing; and a route planning submodule, configured to plan the monitoring route according to an inspection starting point, an inspection endpoint and the two-dimensional planar map.

Further, the data acquiring module is further configured to, upon receipt of the map establishment instruction, traverse the monitored region and acquire the depth data of each obstacle in the monitored region during the traversing; and the map establishing submodule is further configured to project the depth data within a predetermined height range onto a predetermined horizontal plane to obtain corresponding two-dimensional laser radar data; and establish the two-dimensional planar map of the monitored region according to the laser radar data and odometer information corresponding to the laser radar data.

Further, the judging module is further configured to: judge whether there is an obstacle not marked in the two-dimensional planar map, consider that the abnormal factor is present if there is an obstacle not marked in the two-dimensional planar map, or consider that the abnormal factor is not present if there is no obstacle not marked in the two-dimensional planar map; and the executing module is further configured to, if there is an obstacle not marked, mark the obstacle not marked in the two-dimensional planar map according to the current depth data and the current odometer information, update the two-dimensional planar map, update the monitoring route according to the current position and the updated two-dimensional planar map, and inspect the monitored region according to the updated monitoring route.

Further, the judging module is further configured to: judge whether human skeleton data is identified, consider that the abnormal factor is present if the human skeleton data is identified, or consider that the abnormal factor is not present if the human skeleton data is not identified; and the executing module is further configured to: move towards a living body corresponding to the human skeleton data if the human skeleton data is identified; acquire a current facial feature of the living body; and match the current facial feature with a predetermined facial feature in a predetermined living body facial feature database if the current facial feature of the living body is successfully acquired, consider that the abnormal factor is not present if the matching is successful, perform a tracking operation for the living body and generating alarm information if the matching is unsuccessful.

Further, the executing module is further configured to: acquire password information from the living body if the current facial feature of the living body is not successfully acquired; and match the acquired password information with predetermined password information in a predetermined password database, consider that the abnormal factor is not present if the matching is successful, and perform the tracking operation for the living body and generate the alarm information if the matching is unsuccessful.

Further, the robot further includes: a smoke detecting module, configured to, in the course where the robot inspects the monitored region according to the monitoring route, acquire a current smoke concentration value if a predetermined detection time interval is reached; wherein the judging module is further configured to judge whether the current smoke concentration value exceeds a predetermined smoke concentration threshold; and wherein the executing module is further configured to: generate alarm information if the current smoke concentration value exceeds the predetermined smoke concentration threshold, or continue to inspect the monitored region according to the monitoring route if the smoke concentration value does not exceed the predetermined smoke concentration threshold.

With the robot security inspection method based on an environment map and the robot thereof according to the present disclosure, traversing-based inspection may be performed according to the environment map, thereby preventing the dead space in the monitoring; insecure factors may be proactively detected and security policy conformation may be conducted; the insecure factors may be proactively tracked; and the robot is capable of normally operating even without auxiliary illumination at night. The method and the robot according to the present disclosure have a strong initiative, implement active defense against the insecure factors, and greatly improve effectiveness, timeliness and stability of secrete visits and inspections.

### BRIEF DESCRIPTION OF THE DRAWINGS

FIG. 1 is a flowchart of a robot security inspection method based on an environment map according to an embodiment of the present disclosure;

FIG. 2 is a schematic diagram of robot displacement in the security inspection method as illustrated in FIG. 1;

FIG. 3 is a schematic diagram of human body identification according to an embodiment of the present disclosure;

FIG. 4 is a schematic diagram of face recognition and voice identity authentication according to the present disclosure;

FIG. 5 is a schematic structural diagram of a robot according to the present disclosure;

FIG. 6 is a flowchart of a robot security inspection method based on an environment map according to an embodiment of the present disclosure;

FIG. 7 is a partial flowchart of a robot security inspection method based on an environment map according to an embodiment of the present disclosure;

FIG. 8 is a flowchart of a robot security inspection method based on an environment map according to another embodiment of the present disclosure;

FIG. 9 is a partial flowchart of a robot security inspection method based on an environment map according to an embodiment of the present disclosure;

FIG. 10 is a partial flowchart of a robot security inspection method based on an environment map according to an embodiment of the present disclosure;

FIG. 11 is a schematic structural diagram of a robot according to an embodiment of the present disclosure; and

FIG. 12 is a schematic structural diagram of a robot according to another embodiment of the present disclosure.

### DETAILED DESCRIPTION

A robot security inspection method based on an environment map and a robot thereof according to the present disclosure are hereinafter described in detail with reference to the accompanying drawings.

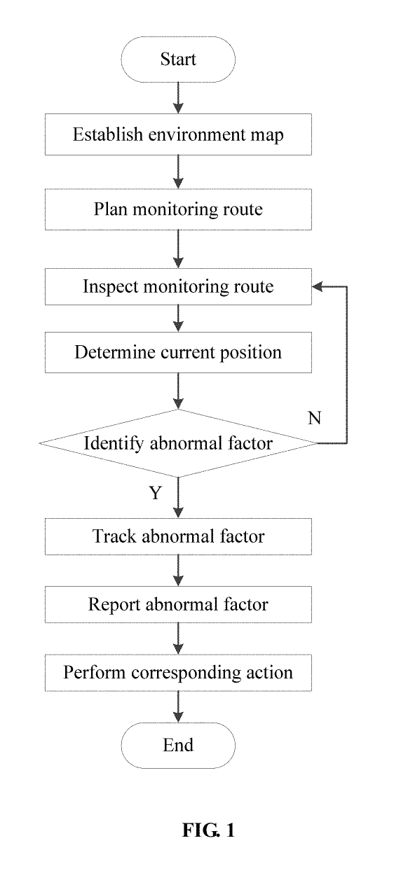

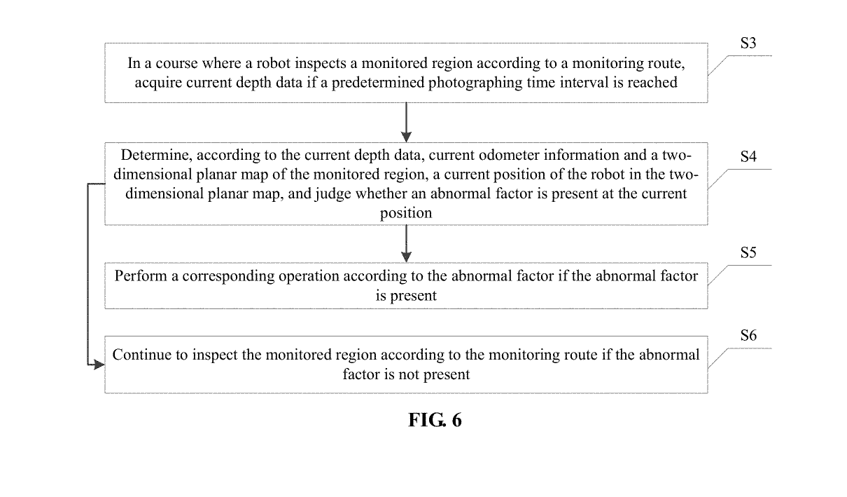

In an embodiment of the present disclosure, as illustrated in FIG. 6 and FIG. 1, a robot security inspection method based on an environment map includes the following steps:

S3: in a course where a robot inspects a monitored region according to a monitoring route, acquiring current depth data if a predetermined photographing time interval is reached;

S4: determining, according to the current depth data, current odometer information and a two-dimensional planar map of the monitored region, a current position of the robot in the two-dimensional planar map, and judging whether an abnormal factor is present at the current position;

S5: performing a corresponding operation according to the abnormal factor if the abnormal factor is present; or

S6: continuing to inspect the monitored region according to the monitoring route if the abnormal factor is not present.

Specifically, when the robot starts inspection, a two-dimensional planar map (which may be uploaded by a user or may be drawn by the robot according to an instruction, or the like) and a monitoring route (which may be defined by the user, or may be planned by the robot according to an inspection starting point, an inspection endpoint and the two-dimensional planar map, or the like) of the monitored region for inspection may be provided.

In the course where the robot inspects the monitored region according to the monitoring route, a depth camera mounted on the robot may acquire a depth image (that is, the current depth data) that may be photographed at the current position thereof according to a specific photographing frequency (which may also be understood as a predetermined photographing time interval). The depth image refers to three-dimensional special coordinate data of a photographed obstacle (or a spatial object) in the monitored region relative to the depth camera. The current depth data may be converted, such that the depth data is converted into corresponding two-dimensional laser radar data (laser radar data may reflect a profile of the obstacle). The two-dimensional laser radar data is compared with the two-dimensional planar map according to the current odometer information, such that the current location of the robot in the current two-dimensional planar map is determined.

The robot matches the current depth data acquired by the current depth camera with a previously established two-dimensional planar map, such that the position of the robot in the current monitored region is determined. The robot moves and carries out the inspection according to the planed monitoring route.

The current position of the robot is determined by the robot by tracking position and posture of the robot in the two-dimensional planar map of the monitored region based on adaptive Monte Carlo localization (AMCL) and a particle filter according to the laser radar data corresponding to the current depth data and the current odometer information.

The odometer information refers to angles executed by a motion mechanism such as a motor in the robot, a rotation count and the like. The odometer information is recorded in any robot that is capable of walking. Generally, the obstacle is located according to the profile of the obstacle that is obtained by conversion of the current depth data. The current odometer information is needed for the sake of ensuring that a more accurate position may be determined in the two-dimensional planar map.

For example, the current depth data may be the profile of a chair whereas there are three chairs in the two-dimensional planar map; in this case, the chair needs to be located according to the current odometer information, such that the current position of the robot in the two-dimensional planar map is determined. The current odometer information may indicate that the motor walks for 10 meters leftward and then walks for 5 meters rightward, such that the current position in the two-dimensional planar map is determined according to the profile of a chair parsed according to current attempt data.

In addition to determining the current position according to the current depth data, the current odometer information and the two-dimensional planar map, whether an abnormal factor is present at the current position may be further judged according to the current data, for example, whether a person (a living body) is detected, and whether a new obstacle and the like that is not marked in the two-dimensional planar map is detected during the inspection. In this way, different operations are performed according to different abnormal factors. If everything is normal, the robot continues the inspection according to the monitoring route.

In this embodiment, the robot may inspect the monitored region according to the monitoring route, such that labor force is reduced and no camera needs to be deployed in the monitored region, in addition, if an abnormal factor is detected during the inspection, some measures may be timely taken.

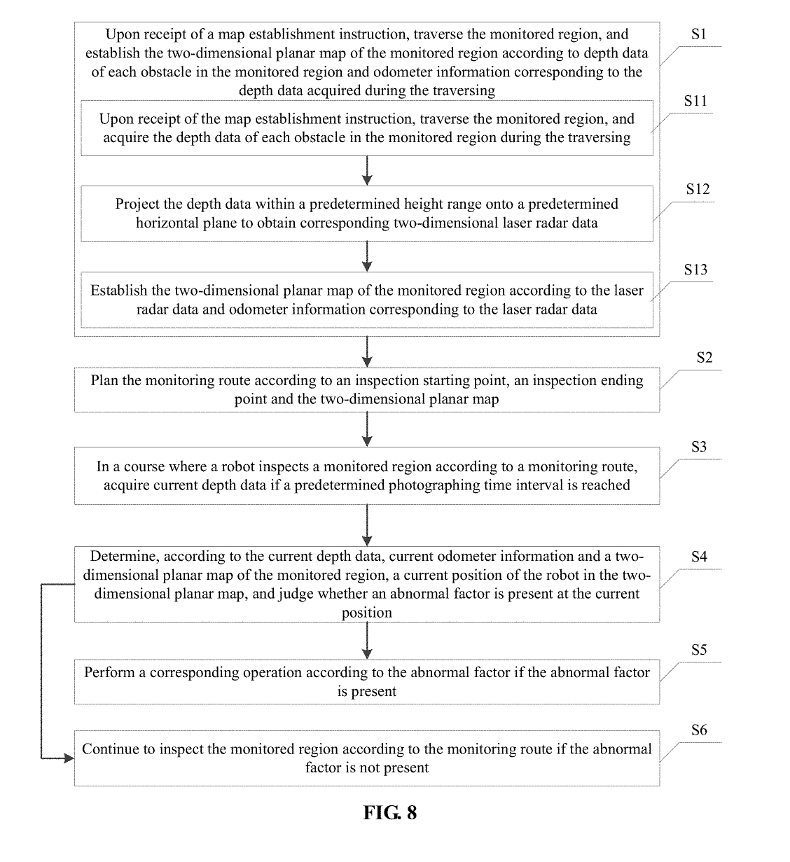

In another embodiment of the present disclosure, based on the above embodiment, as illustrated in FIG. 8, prior to step S3, the method further includes:

S1: upon receipt of a map establishment instruction, traversing, by the robot, the monitored region, and establishing the two-dimensional planar map of the monitored region according to depth data of each obstacle in the monitored region and odometer information corresponding to the depth data acquired during the traversing; and

S2: planning the monitoring route according to an inspection starting point, an inspection endpoint and the two-dimensional planar map.

Specifically, when the robot desires to inspect a monitored region, the two-dimensional planar map of this monitored region needs to be inevitably acquired, to plan the monitoring route and determine the current position during the inspection and the like.

In this embodiment, the two-dimensional planar map is established by the robot, and prior to the normal inspection, an operating personnel controls the robot to traverse the monitored region to be inspected.

When the robot walks in the monitored region, the robot acquires depth data of each obstacle in the monitored region by using the depth camera mounted on the head of the robot, and then establishes the two-dimensional planar map according to the acquired odometer information corresponding to the depth data. In this way, the robot may establish the two-dimensional planar map while walking. After the robot traverses the monitored region, the two-dimensional planar map is established. Nevertheless, prior to the normal inspection, a random route-changing program inside the robot may control the robot to traverse the monitored region, so as to establish the two-dimensional planar map.

After the two-dimensional planar map is acquired, the operating personnel may input the inspection starting point and the inspection endpoint, such that the robot plans the monitoring route according to the two-dimensional planar map, which is more intelligent and labor-saving. During planning of the monitoring route by the robot according to the established two-dimensional planar map, the Dijkstra optimal path algorithm is employed to calculate a least-expenditure path from the inspection starting point to the inspection endpoint in the two-dimensional planar map, and use the path as the monitoring route of the robot.

Preferably, as illustrated in FIG. 8, step S1 specifically includes the following steps:

S11: upon receipt of the map establishment instruction, traversing, by the robot, the monitored region, and acquiring the depth data of each obstacle in the monitored region during the traversing;

S12: projecting the depth data within a predetermined height range onto a predetermined horizontal plane to obtain corresponding two-dimensional laser radar data; and

S13: establishing the two-dimensional planar map of the monitored region according to the laser radar data (the corresponding depth data) and odometer information corresponding to the laser radar data.

Specifically, the two-dimensional planar map (that is, a two-dimensional grid map) of an unknown environment (that is, a monitored region) is established by using the Gmapping algorithm in the simultaneous localization and mapping (SLAM), and the specific process is as follows:

1) The depth camera may acquire a depth image (that is, the depth data, or depth distance data) during the course of traversing the monitored region, and may convert three-dimensional spatial depth data into two-dimensional laser radar data by projecting the depth data within the predetermined height range onto the horizontal plane of the depth camera.

For example, if the height from the depth camera to the ground is Z=50 cm, and the predetermined height range is set to 0 to 100 cm, the depth data satisfying the height of 0 to 100 cm is projected onto the horizontal plane with the height of Z=50, such that the corresponding two-dimensional laser radar data is acquired.

2) The Gmapping algorithm finally constructs the two-dimensional grid map of the unknown environment (that is, the two-dimensional planar map of the monitored region) by virtue of particle filtering according to the laser radar data obtained upon conversion in combination with the odometer information of the robot.

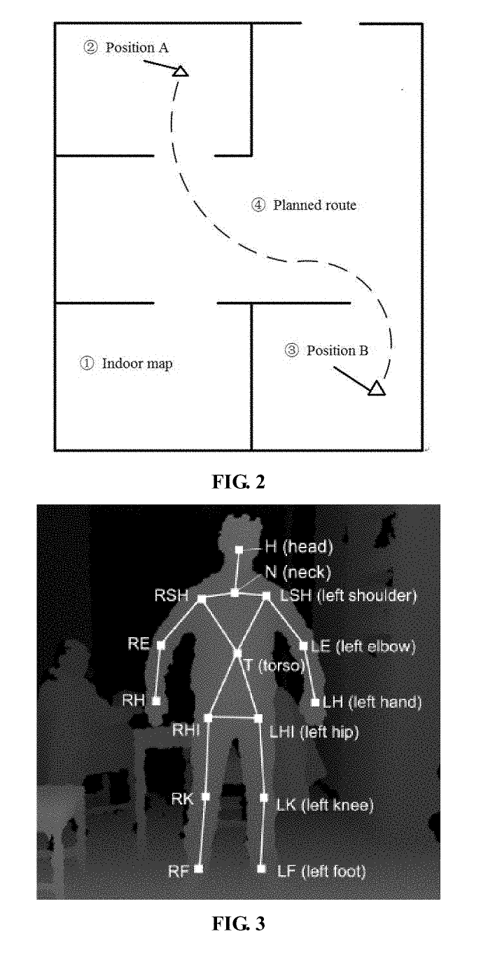

As illustrated in FIG. 2, in the course where the robot carries out security inspection, four pieces of information are mainly included:

(1) a two-dimensional planar map of an inspection environment (that is, the monitored region) established by the robot;

(2) an inspection starting position (inspection starting point) A;

(3) an inspection destination position (inspection endpoint) B; and

(4) an inspection path (that is, the monitoring route) planed by the robot from the inspection starting point A to the inspection endpoint B.

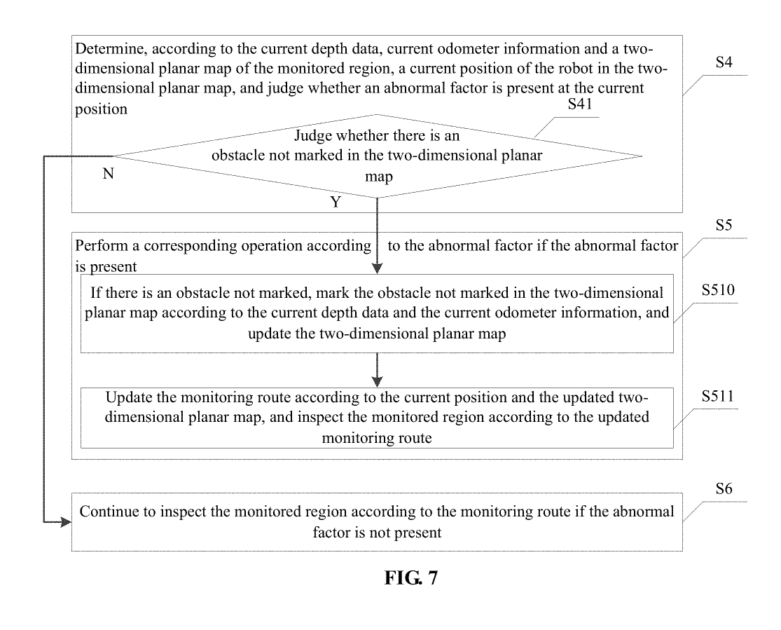

In another embodiment of the present disclosure, based on the above embodiment, as illustrated in FIG. 7, step S4 of determining, according to the current depth data, current odometer information and a two-dimensional planar map of the monitored region, a current position of the robot in the two-dimensional planar map, and judging whether an abnormal factor is present at the current position includes the following steps:

S41: judging whether there is an obstacle not marked in the two-dimensional planar map, considering that the abnormal factor is present if there is an obstacle not marked in the two-dimensional planar map, or considering that the abnormal factor is not present if there is no obstacle not marked in the two-dimensional planar map; and

step S5 includes the following steps:

S510: if there is an obstacle not marked, marking the obstacle not marked in the two-dimensional planar map according to the current depth data and the current odometer information, and updating the two-dimensional planar map; and

S511: updating the monitoring route according to the current position and the updated two-dimensional planar map, and inspecting the monitored region according to the updated monitoring route.

Specifically, if there is no abnormal factor, the robot may carry out inspection according to the monitoring route in combination with the current position.

However, if there is no obstacle not marked in the two-dimensional planar map during the progress of the robot, it is considered that an abnormal factor is detected, and the obstacle may be marked in the two-dimensional planar map to update the two-dimensional planar map of the monitored region. The obstacle not marked is marked in the two-dimensional planar map by using the same method for establishing the two-dimensional planar map.

After the two-dimensional planar map is updated, the robot may re-plan the monitoring route according to the current position, the endpoint of the original monitoring route and the updated two-dimensional planar map, and continue the inspection according to the current position and the updated monitoring route.

The robot may update the monitoring route thereof according to the updated two-dimensional planar map. Therefore, the inspection is more flexible and achieves a better inspection result.

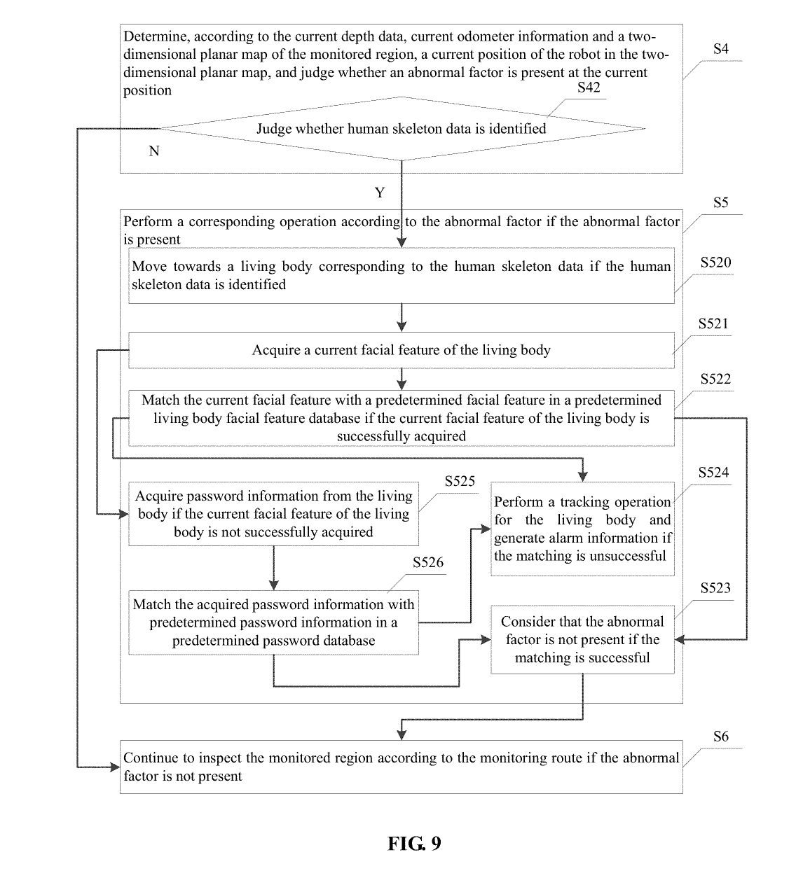

In another embodiment of the present disclosure, based on the above embodiment, as illustrated in FIG. 9, step S4 of determining, according to the current depth data, current odometer information and a two-dimensional planar map of the monitored region, a current position of the robot in the two-dimensional planar map, and judging whether an abnormal factor is present at the current position includes the following steps:

S42: judging whether human skeleton data is identified, considering that the abnormal factor is present if the human skeleton data is identified, or considering that the abnormal factor is not present if the human skeleton data is not identified; and

step S5 includes the following steps:

S520: moving towards a living body corresponding to the human skeleton data if the human skeleton data is identified;

S521: acquiring a current facial feature of the living body;

S522: matching the current facial feature with a predetermined facial feature in a predetermined living body facial feature database if the current facial feature of the living body is successfully acquired;

S523: considering that the abnormal factor is not present if the matching is successful; and

S524: performing the tracking operation for the living body and generating the alarm information if the matching is unsuccessful.

Specifically, in addition to judging whether there is an obstacle not marked in the two-dimensional planar map according to the current depth data, the robot may further judge whether human skeleton data is identified, such that whether there is a living body during the inspection is judged, to judge whether the abnormal factor is present at the current position. Whether there is an obstacle not marked is firstly judged, and then whether the human skeleton data is identified is judged; or whether the human skeleton data is identified is firstly judged, and then whether there is an obstacle not marked is judged; or the two judgments are performed parallelly. The time sequence of the judgments is not specifically limited.

As illustrated in FIG. 3, using a living body as an example, identification of human skeleton data is as follows: The human skeleton data has been identified if the current depth image (that is, the current depth data) acquired by the depth camera includes lines as illustrated in FIG. 3.

Once the human skeleton data is identified, it is considered that the robot has detected an abnormal factor, and the robot may perform a corresponding operation according to the identified skeleton data.

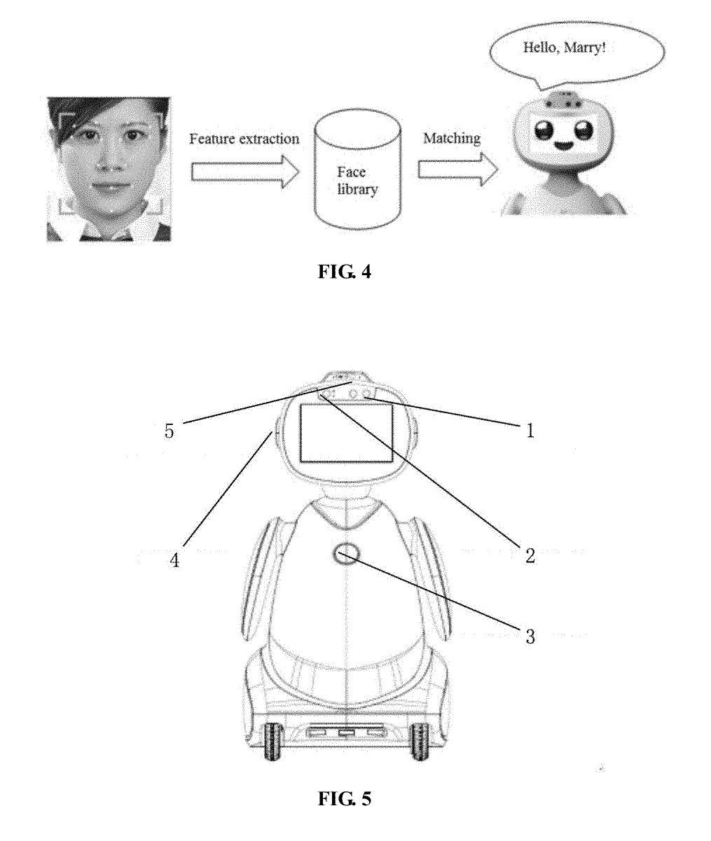

As illustrated in FIG. 4, using a living body as an example, after the human skeleton data is detected, since whether the person is a secure factor or not needs to be judged, the robot needs to approach this person to acquire the current facial feature of the person, and judge whether the current living body is a secure factor is judged by means of face recognition. The face recognition may include the following steps:

When the robot detects the human skeleton data, the robots approaches the person, and detects the current facial feature of the person by using an RGB camera of the robot.

The current facial feature is matched with various facial features stored in a predetermined living body facial feature database; if the matching is successful, identity verification is completed and the person is not tracked; and if the matching is unsuccessful, the person is identified as a dangerous factor (a stranger).

The predetermined living body facial feature database may store a plurality of predetermined facial features, wherein the plurality of predetermined facial features pertain to different persons and may probably appear in the monitored region. If the current facial feature fails to successfully match with any of the predetermined facial features, this person is a stranger and is a dangerous factor. As such, the person needs to be tracked, and alarm information needs to be generated. Generation of the alarm information is performing a corresponding operation according to a predefined security policy or a guardian operation. For example, the predefined security policy is generating a buzzer alarm, and the guardian operation is sending the alarm information or the like to the guardian.

If the current facial feature successfully matches with any of the predetermined facial features, the person is not a dangerous factor and no abnormal factor is present. As such, the robot may continue the inspection according to the monitoring route. If the robot deviates from the monitoring route during acquisition of the current facial feature, the robot may return to the origin upon judging that no abnormal factor is present, and continue the inspection according to the monitoring route; or the robot may determine the current position, and re-plans the monitoring route or the like according to the current position and the inspection terminal.

Preferably, following step S521, the method further includes the following steps:

S525: acquiring password information from the living body if the current facial feature of the living body is not successfully acquired;

S526: matching the acquired password information with predetermined password information in a predetermined password database;

S523: considering that the abnormal factor is not present if the matching is successful; and

S524: performing the tracking operation for the living body and generating the alarm information if the matching is unsuccessful.

Specifically, in case of night and insufficient light, the RGB camera fails to normally identify the face of a person under test, and perform identity verification for the person under test by virtue of voice password.

When the robot finds that the current facial feature of the living body fails to be successfully acquired, the robot may acquire password information from the living body. For example, the robot asks the living body for the password information; upon hearing the voice message from the robot, the living body may report the password information; and the robot receives the password information reported by the living body via the microphone array, and then matches the received password information with predetermined password information stored in a predetermined password database.

The predetermined password database may store a plurality of pieces of predetermined password information. The matching is considered to be successful as long as the password information reported by the living body matches with any of the plurality of pieces of predetermined password information, and the matching is considered to be unsuccessful as long as the password information reported by the living body fails to match with any of plurality of pieces of predetermined password information. The predetermined password information may be a sentence, a song title or the like, which may be freely defined by the guardian (that is, the user of the robot).

When the matching is successful, the robot considers that the current living body is not a dangerous factor and no abnormal factor is present, and in this case, the robot continues the inspection according to the monitoring route; and when the matching is unsuccessful, the robot considers that the current living body is a dangerous factor, performing a tacking operation for the living body and generates alarm information. Generation of the alarm information is performing a corresponding operation according to a predefined security policy or a guardian operation. For example, the predefined security policy is generating a buzzer alarm, and the guardian operation is sending the alarm information or the like to the guardian.

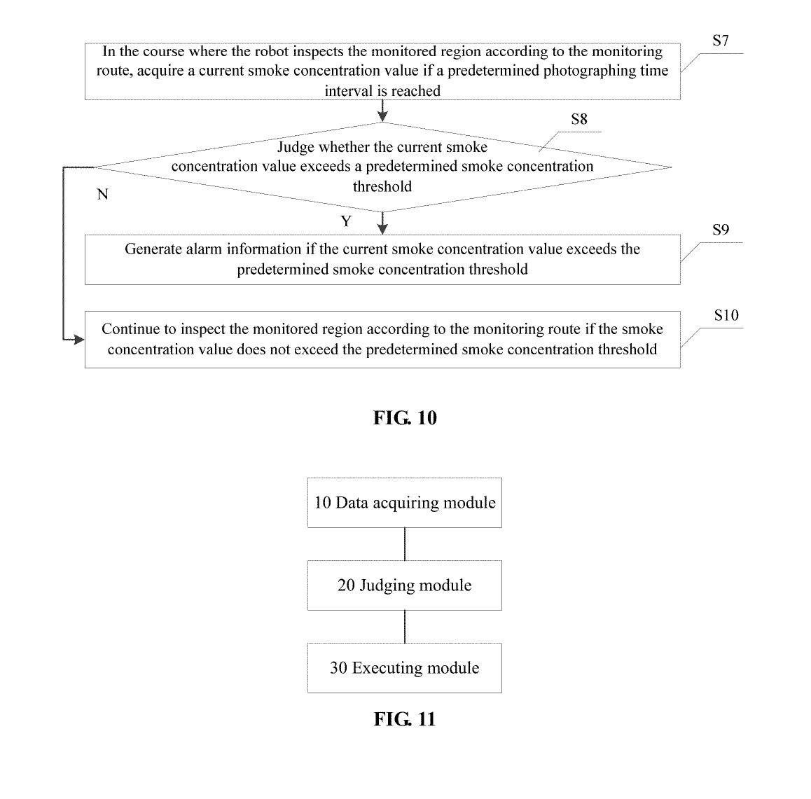

In another embodiment of the present disclosure, based on the above embodiment, as illustrated in FIG. 10, the method further includes the following steps:

S7: in the course where the robot inspects the monitored region according to the monitoring route, acquiring a current smoke concentration value if a predetermined detection time interval is reached;

S8: judging whether the current smoke concentration value exceeds a predetermined smoke concentration threshold;

S9: generating alarm information if the current smoke concentration value exceeds the predetermined smoke concentration threshold; or

S10: continuing to inspect the monitored region according to the monitoring route if the smoke concentration value does not exceed the predetermined smoke concentration threshold.

Specifically, in the course where the robot carries out inspection according to the monitoring route, a smoke sensor thereof may measure the smoke concentration value of the monitored region, and the robot may judge the acquired current smoke concentration value. If the smoke concentration value exceeds the predetermined smoke concentration threshold, the robot considers that a dangerous factor is present and generates alarm information.

Generation of the alarm information is performing a corresponding operation according to a predefined security policy or a guardian operation. For example, the predefined security policy is generating a buzzer alarm, and the guardian operation is sending the alarm information or the like to the guardian.

Judgment of the current smoke concentration value, identification of the human skeleton data and detection of the obstacle not marked may be performed parallelly, or may be performed according to a time sequence. For example, when the current position is determined, whether a current smoke attempt value exceeds the predetermined smoke concentration threshold is firstly judged; if the current smoke attempt value exceeds the predetermined smoke concentration threshold, the robot generates alarm information and waits for the guardian to process; if the current smoke attempt value does not exceed the predetermined smoke concentration threshold, whether the human skeleton data is identified is judged; if the human skeleton data is identified, the robot acquires the current facial feature or password information and performs matching thereof; if the matching is unsuccessful, the robot performs a tacking operation, and generates alarm information; if the matching is successful, the robot further judges whether an obstacle not marked is detected; if no obstacle not marked is detected, the robot continues the inspection according to the monitoring route and repeats the above steps; and if the obstacle not marked is detected, the robot updates the two-dimensional planar map, carries out the inspection according to the updated monitoring route and repeats the above steps.

Inspection by using the robot reduces the labor force, and achieves flexible monitoring. The depth camera has the night vision function, is capable of feeding back, generating alarms and proactively tracking abnormal factors, smoke concentrations and the like, and thus achieves a better monitoring effect.

As illustrated in FIG. 5, a robot for use in the security inspection method according to the above technical solution includes:

a depth camera 1, mainly configured to acquire depth data of an indoor object relative to the robot, and an internal structure of a living body, so as to establish a two-dimensional grid map of a monitored region and locate the robot; wherein since the depth camera employs an infrared ray structure to detect the depth of the object, in the dark night, the depth camera is still capable of operating;

an RGB camera 2, configured to acquire a color image of the monitored region for face recognition and scenario view;

a smoke sensor 3, configured to sense smoke in the monitored region;

a microphone array 4, configured to pick up an external sound or make an approximate judgment for the direction of a sound source; and

a speaker 5, configured to play sounds, such as inquiries and alarms.

In another embodiment of the present disclosure, as illustrated in FIG. 11, a robot includes:

a data acquiring module 10, configured to, in a course wherein a robot inspects a monitored region according to a monitoring route, acquire current depth data if a predetermined photographing time interval is reached; wherein the current depth data includes: distance data of an obstacle relative to the robot in a current monitoring region, and an internal structure of a living body (if there is a living body);

a judging module 20, configured to, determine, according to the current depth data, current odometer information and a two-dimensional planar map of the monitored region, a current position of the robot in the two-dimensional planar map, and judge whether an abnormal factor is present at the current position; and

an executing module 30, configured to, perform a corresponding operation according to the abnormal factor if the abnormal factor is present, or continue to inspect the monitored region according to the monitoring route if the abnormal factor is not present.

Specifically, when the robot starts inspection, a two-dimensional planar map (which may be uploaded by a user or may be drawn by the robot according to an instruction, or the like) and a monitoring route (which may be defined by the user, or may be planned by the robot according to an inspection starting point, an inspection endpoint and the two-dimensional planar map, or the like) of the monitored region for inspection may be provided. The data acquiring module is the depth camera of the robot.

In the course where the robot inspects the monitored region according to the monitoring route, a depth camera mounted on the robot may acquire a depth image (that is, the current depth data) that may be photographed at the current position thereof according to a specific photographing frequency (which may also be understood as a predetermined photographing time interval). The depth image refers to three-dimensional special coordinate data of a photographed obstacle (or a spatial object) in the monitored region relative to the depth camera. The current depth data may be converted, such that the depth data is converted into corresponding two-dimensional laser radar data (laser radar data may reflect a profile of the obstacle). The two-dimensional laser radar data is compared with the two-dimensional planar map according to the current odometer information, such that the current location of the robot in the current two-dimensional planar map is determined.

The robot matches the current depth data acquired by the current depth camera with a previously established two-dimensional planar map, such that the position of the robot in the current monitored region is determined. The robot moves and carries out the inspection according to the planed monitoring route.

The current position of the robot is determined by the robot by tracking position and posture of the robot in the two-dimensional planar map of the monitored region based on adaptive Monte Carlo localization (AMCL) and a particle filter according to the laser radar data corresponding to the current depth data and the current odometer information.

The odometer information refers to angles executed by a motion mechanism such as a motor in the robot, a rotation count and the like. The odometer information is recorded in any robot that is capable of walking. Generally, the obstacle is located according to the profile of the obstacle that is obtained by conversion of the current depth data. The current odometer information is needed for the sake of ensuring that a more accurate position may be determined in the two-dimensional planar map.

For example, the current depth data may be the profile of a chair whereas there are three chairs in the two-dimensional planar map; in this case, the chair needs to be located according to the current odometer information, such that the current position of the robot in the two-dimensional planar map is determined. The current odometer information may indicate that the motor walks for 15 meters leftward and then walks for 7 meters rightward, such that the current position in the two-dimensional planar map is determined according to the profile of a chair parsed according to current attempt data.

In addition to determining the current position according to the current depth data, the current odometer information and the two-dimensional planar map, whether an abnormal factor is present at the current position may be further judged according to the current data, for example, whether a person (a living body) is detected, and whether a new obstacle and the like that is not marked in the two-dimensional planar map is detected during the inspection. In this way, different operations are performed according to different abnormal factors. If everything is normal, the robot continues the inspection according to the monitoring route.

In this embodiment, the robot may inspect the monitored region according to the monitoring route, such that labor force is reduced and no camera needs to be deployed in the monitored region, in addition, if an abnormal factor is detected during the inspection, an action may be timely taken.

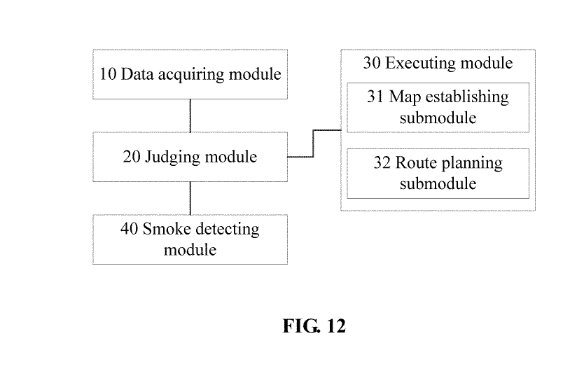

In another embodiment of the present disclosure, based on the above embodiment, as illustrated in FIG. 12, the executing module 30 includes:

a map establishing submodule 31, configured to, upon receipt of a map establishment instruction, traverse the monitored region, and establish the two-dimensional planar map of the monitored region according to depth data of each obstacle in the monitored region and odometer information corresponding to the depth data acquired during the traversing; and

a route planning submodule 32, configured to plan the monitoring route according to an inspection starting point, an inspection endpoint and the two-dimensional planar map.

Specifically, when the robot desires to inspect a monitored region, the two-dimensional planar map of this monitored region needs to be inevitably acquired, to plan the monitoring route and determine the current position during the inspection and the like.

In this embodiment, the two-dimensional planar map is established by the robot, and prior to the normal inspection, an operating personnel controls the robot to traverse the monitored region to be inspected. When the robot walks in the monitored region, the robot acquires depth data of each obstacle in the monitored region by using the depth camera mounted on the head of the robot, and then establishes the two-dimensional planar map according to the acquired odometer information corresponding to the depth data. In this way, the robot may establish the two-dimensional planar map while walking. After the robot traverses the monitored region, the two-dimensional planar map is established. Nevertheless, prior to the normal inspection, a random route-changing program inside the robot may control the robot to traverse the monitored region, so as to establish the two-dimensional planar map.

After the two-dimensional planar map is acquired, the operating personnel may input the inspection starting point and the inspection endpoint, such that the robot plans the monitoring route according to the two-dimensional planar map, which is more intelligent and labor-saving. During planning of the monitoring route by the robot according to the established two-dimensional planar map, the Dijkstra optimal path algorithm is employed to calculate a least-expenditure path from the inspection starting point to the inspection endpoint in the two-dimensional planar map, and use the path as the monitoring route of the robot.

Preferably, the data acquiring module 10 is further configured to, upon receipt of the map establishment instruction, traverse the monitored region, and acquire the depth data of each obstacle in the monitored region during the traversing; and

the map establishing submodule 31 is further configured to, project the depth data within a predetermined height range onto a predetermined horizontal plane to obtain corresponding two-dimensional laser radar data (the corresponding depth data); and establish the two-dimensional planar map of the monitored region according to the laser radar data and odometer information corresponding to the laser radar data.

Specifically, the two-dimensional planar map (that is, a two-dimensional grid map) of an unknown environment (that is, a monitored region) is established by using the Gmapping algorithm in the simultaneous localization and mapping (SLAM), and the specific process is as follows:

1) The depth camera may acquire a depth image (that is, the depth data, or depth distance data) in the course of traversing the monitored region, and may convert three-dimensional spatial depth data into two-dimensional laser radar data by projecting the depth data within the predetermined height range onto the horizontal plane of the depth camera.

For example, if the height from the depth camera to the ground is Z=50 cm, and the predetermined height range is set to 0 to 100 cm, the depth data satisfying the height of 0 to 100 cm is projected onto the horizontal plane with the height of Z=50, such that the corresponding two-dimensional laser radar data is acquired.

2) The Gmapping algorithm finally constructs the two-dimensional grid map of the unknown environment (that is, the two-dimensional planar map of the monitored region) by virtue of particle filtering according to the laser radar data obtained upon conversion in combination with the odometer information of the robot.

In another embodiment of the present disclosure, based on the above embodiment, the judging module 20 is further configured to, judge whether there is an obstacle not marked in the two-dimensional planar map, consider that the abnormal factor is present if there is an obstacle not marked in the two-dimensional planar map, or consider that the abnormal factor is not present if there is no obstacle not marked in the two-dimensional planar map; and

the executing module 30 is further configured to, if there is an obstacle not marked, mark the obstacle not marked in the two-dimensional planar map according to the current depth data and the current odometer information, update the two-dimensional planar map, update the monitoring route according to the current position and the updated two-dimensional planar map, and inspect the monitored region according to the updated monitoring route.

Specifically, if there is no abnormal factor, the robot may carry out inspection according to the monitoring route in combination with the current position.

However, if there is no obstacle not marked in the two-dimensional planar map during the progress of the robot, it is considered that an abnormal factor is detected, and the obstacle may be marked in the two-dimensional planar map to update the two-dimensional planar map of the monitored region. The obstacle not marked is marked in the two-dimensional planar map by using the same method for establishing the two-dimensional planar map.

After the two-dimensional planar map is updated, the robot may re-plan the monitoring route according to the current position, the endpoint of the original monitoring route and the updated two-dimensional planar map, and continue the inspection according to the current position and the updated monitoring route.

The robot may update the monitoring route thereof according to the updated two-dimensional planar map. Therefore, the inspection is more flexible and achieves a better inspection result.

In another embodiment of the present disclosure, based on the above embodiment, the judging module 20 is further configured to: judge whether human skeleton data is identified, consider that the abnormal factor is present if the human skeleton data is identified, or consider that the abnormal factor is not present if the human skeleton data is not identified; and

the executing module 30 is further configured to: move towards a living body corresponding to the human skeleton data if the human skeleton data is identified;

acquire a current facial feature of the living body;

match the current facial feature with a predetermined facial feature in a predetermined living body facial feature database if the current facial feature of the living body is successfully acquired, consider that the abnormal factor is not present if the matching is successful, perform a tracking operation for the living body and generating alarm information if the matching is unsuccessful.

Specifically, in addition to judging whether there is an obstacle not marked in the two-dimensional planar map according to the current depth data, the robot may further judge whether human skeleton data is identified, such that whether there is a living body during the inspection is judged, to judge whether the abnormal factor is present at the current position. Whether there is an obstacle not marked is firstly judged, and then whether the human skeleton data is identified is judged; or whether the human skeleton data is identified is firstly judged, and then whether there is an obstacle not marked is judged; or the two judgments are performed parallelly. The time sequence of the judgments is not specifically limited.

The RGB camera of the robot acquires the current facial feature of the living body.

The predetermined living body facial feature database may store a plurality of predetermined facial features, wherein the plurality of predetermined facial features pertain to different persons and may probably appear in the monitored region. If the current facial feature fails to successfully match any of the predetermined facial features, this person is a stranger and is a dangerous factor. As such, the person needs to be tracked, and alarm information needs to be generated. Generation of the alarm information is performing a corresponding operation according to a predefined security policy or a guardian operation. For example, the predefined security policy is generating a buzzer (or speaker) alarm, and the guardian operation is sending the alarm information or the like to the guardian.

If the current facial feature successfully matches with any of the predetermined facial features, the person is not a dangerous factor and no abnormal factor is present. As such, the robot may continue the inspection according to the monitoring route. If the robot deviates from the monitoring route during acquisition of the current facial feature, the robot may return to the origin upon judging that no abnormal factor is present, and continue the inspection according to the monitoring route; or the robot may determine the current position, and re-plans the monitoring route or the like according to the current position and the inspection terminal.

Preferably, the executing module 30 is further configured to:

acquire password information from the living body if the current facial feature of the living body is not successfully acquired; and

match the acquired password information with predetermined password information in a predetermined password database, consider that the abnormal factor is not present if the matching is successful, and perform the tracking operation for the living body and generate the alarm information if the matching is unsuccessful.

Specifically, the living body is queried by using the speaker, and the password information is acquired by using the microphone array.

In case of night and insufficient light, the RGB camera fails to normally identify the face of a person under test, and perform identity verification for the person under test by virtue of voice password.

When the robot finds that the current facial feature of the living body fails to be successfully acquired, the robot may acquire password information from the living body. For example, the robot asks the living body for the password information; upon hearing the voice message from the robot, the living body may report the password information; and the robot receives the password information reported by the living body via the microphone array, and then matches the received password information with predetermined password information stored in a predetermined password database.

The predetermined password database may store a plurality of pieces of predetermined password information. The matching is considered to be successful as long as the password information reported by the living body matches with any of the plurality of pieces of predetermined password information, and the matching is considered to be unsuccessful as long as the password information reported by the living body fails to match with any of plurality of pieces of predetermined password information. The predetermined password information may be a sentence, a song title or the like, which may be freely defined by the guardian (that is, the user of the robot).

When the matching is successful, the robot considers that the current living body is not a dangerous factor and no abnormal factor is present, and in this case, the robot continues the inspection according to the monitoring route; and when the matching is unsuccessful, the robot considers that the current living body is a dangerous factor, performs a tacking operation for the living body and generates alarm information. Generation of the alarm information is performing a corresponding operation according to a predefined security policy or a guardian operation. For example, the predefined security policy is generating a buzzer alarm, and the guardian operation is sending the alarm information or the like to the guardian.

In another embodiment of the present disclosure, based on the above embodiment, as illustrated in FIG. 12, the robot further includes:

a smoke detecting module 40, configured to, in the course where the robot inspects the monitored region according to the monitoring route, acquire a current smoke concentration value if a detection photographing time interval is reached;

wherein the judging module 20 is further configured to judge whether the current smoke concentration value exceeds a predetermined smoke concentration threshold; and

wherein the executing module 30 is further configured to generate alarm information if the current smoke concentration value exceeds the predetermined smoke concentration threshold, and continue to inspect the monitored region according to the monitoring route if the smoke concentration value does not exceed the predetermined smoke concentration threshold.

Specifically, the smoke detecting module is a smoke sensor of the robot. The smoke sensor may acquires the current smoke concentration value at a predetermined frequency, that is, in the course where the robot inspects the monitored region according to the monitoring route, the smoke detecting module acquires the current smoke concentration value if the predetermined detection time interval is reached.

In the course where the robot carries out inspection according to the monitoring route, a smoke sensor thereof may measure the smoke concentration value of the monitored region, and the robot may judge the acquired current smoke concentration value. If the smoke concentration value exceeds the predetermined smoke concentration threshold, the robot considers that a dangerous factor is present and generates alarm information.

Generation of the alarm information is performing a corresponding operation according to a predefined security policy or a guardian operation. For example, the predefined security policy is generating a buzzer alarm, and the guardian operation is sending the alarm information or the like to the guardian.

Judgment of the current smoke concentration value, identification of the human skeleton data and detection of the obstacle not marked may be performed parallelly, or may be performed according to a time sequence. For example, when the current position is determined, whether a current smoke attempt value exceeds the predetermined smoke concentration threshold is firstly judged; if the current smoke attempt value exceeds the predetermined smoke concentration threshold, the robot generates alarm information and waits for the guardian to process; if the current smoke attempt value does not exceed the predetermined smoke concentration threshold, whether the human skeleton data is identified is judged; if the human skeleton data is identified, the robot acquires the current facial feature or password information and performs matching thereof; if the matching is unsuccessful, the robot performs a tacking operation, and generates alarm information; if the matching is successful, the robot further judges whether an obstacle not marked is detected; if no obstacle not marked is detected, the robot continues the inspection according to the monitoring route and repeats the above steps; and if the obstacle not marked is detected, the robot updates the two-dimensional planar map, carries out the inspection according to the updated monitoring route and repeats the above steps.

Inspection by using the robot reduces the labor force, and achieves flexible monitoring. The depth camera has the night vision function, is capable of feeding back, generating alarms and proactively tracking abnormal factors, smoke concentrations and the like, and thus achieves a better monitoring effect.

The above embodiments are merely used to illustrate the technical solutions of the present disclosure, instead of limiting the protection scope of the present disclosure. Any modification, equivalent replacement, or improvement made without departing from the spirit and principle of the present disclosure should fall within the protection scope defined by the appended claims of the present disclosure.

What is claimed is:

1. A robot security inspection method based on an environment map, comprising:
S3: in a course where a robot inspects a monitored region according to a monitoring route, acquiring current depth data if a predetermined photographing time interval is reached;
S4: determining, according to the current depth data, current odometer information and a two-dimensional planar map of the monitored region, a current position of the robot in the two-dimensional planar map, and judging whether an abnormal factor is present at the current position;
S5: performing a corresponding operation according to the abnormal factor if the abnormal factor is present; or
S6: continuing to inspect the monitored region according to the monitoring route if the abnormal factor is not present.

2. The robot security inspection method based on an environment map according to claim 1, wherein prior to step S3, the method further comprises:
S1: upon receipt of a map establishment instruction, traversing, by the robot, the monitored region, and establishing the two-dimensional planar map of the monitored region according to depth data of each obstacle in the monitored region and odometer information corresponding to the depth data acquired during the traversing; and
S2: planning the monitoring route according to an inspection starting point, an inspection endpoint and the two-dimensional planar map.

3. The robot security inspection method based on an environment map according to claim 2, wherein step S1 comprises the following steps:
S11: upon receipt of the map establishment instruction, traversing, by the robot, the monitored region, and acquiring the depth data of each obstacle in the monitored region during the traversing;
S12: projecting the depth data within a predetermined height range onto a predetermined horizontal plane to obtain corresponding two-dimensional laser radar data; and
S13: establishing the two-dimensional planar map of the monitored region according to the laser radar data and odometer information corresponding to the laser radar data.

4. The robot security inspection method based on an environment map according to claim 1, wherein:
step S4 comprises the following steps:
S41: judging whether there is an obstacle not marked in the two-dimensional planar map, considering that the abnormal factor is present if there is an obstacle not marked in the two-dimensional planar map, or considering that the abnormal factor is not present if there is no obstacle not marked in the two-dimensional planar map; and
step S5 comprises the following steps:
S510: if there is an obstacle not marked, marking the obstacle not marked in the two-dimensional planar map according to the current depth data and the current odometer information, and updating the two-dimensional planar map; and
S511: updating the monitoring route according to the current position and the updated two-dimensional planar map, and inspecting the monitored region according to the updated monitoring route.

5. The robot security inspection method based on an environment map according to claim 1, wherein
step S4 comprises the following steps:
S42: judging whether human skeleton data is identified, considering that the abnormal factor is present if the human skeleton data is identified, or considering that the abnormal factor is not present if the human skeleton data is not identified; and
step S5 comprises the following steps:
S520: moving towards a living body corresponding to the human skeleton data if the human skeleton data is identified;
S521: acquiring a current facial feature of the living body;
S522: matching the current facial feature with a predetermined facial feature in a predetermined living body facial feature database if the current facial feature of the living body is successfully acquired;
S523: considering that the abnormal factor is not present if the matching is successful; and
S524: performing a tracking operation for the living body and generating alarm information if the matching is unsuccessful.

6. The robot security inspection method based on an environment map according to claim 5, wherein following step S521, the method further comprises:
S525: acquiring password information from the living body if the current facial feature of the living body is not successfully acquired;
S526: matching the acquired password information with predetermined password information in a predetermined password database;
S523: considering that the abnormal factor is not present if the matching is successful; and
S524: performing the tracking operation for the living body and generating the alarm information if the matching is unsuccessful.

7. The robot security inspection method based on an environment map according to claim 1, further comprising:
S7: in the course where the robot inspects the monitored region according to the monitoring route, acquiring a current smoke concentration value if a predetermined detection time interval is reached;
S8: judging whether the current smoke concentration value exceeds a predetermined smoke concentration threshold;
S9: generating alarm information if the current smoke concentration value exceeds the predetermined smoke concentration threshold; or
S10: continuing to inspect the monitored region according to the monitoring route if the smoke concentration value does not exceed the predetermined smoke concentration threshold.

8. A robot, comprising:
a data acquiring module, configured to, in a course where a robot inspects a monitored region according to a monitoring route, acquire current depth data if a predetermined photographing time interval is reached;
a judging module, configured to determine, according to the current depth data, current odometer information and a two-dimensional planar map of the monitored region, a current position of the robot in the two-dimensional planar map, and judge whether an abnormal factor is present at the current position; and
an executing module, configured to perform a corresponding operation according to the abnormal factor if the abnormal factor is present, or continue to inspect the monitored region according to the monitoring route if the abnormal factor is not present.

9. The robot according to claim 8, wherein the executing module comprises:
a map establishing submodule, configured to, upon receipt of a map establishment instruction, traverse the monitored region, and establish the two-dimensional planar map of the monitored region according to depth data of each obstacle in the monitored region and odometer information corresponding to the depth data acquired during the traversing; and
a route planning submodule, configured to plan the monitoring route according to an inspection starting point, an inspection endpoint and the two-dimensional planar map.

10. The robot according to claim 9, wherein:
the data acquiring module is further configured to, upon receipt of the map establishment instruction, traverse the monitored region and acquire the depth data of each obstacle in the monitored region during the traversing; and
the map establishing submodule is further configured to project the depth data within a predetermined height range onto a predetermined horizontal plane to obtain corresponding two-dimensional laser radar data; and establish the two-dimensional planar map of the monitored region according to the laser radar data and odometer information corresponding to the laser radar data.

11. The robot according to claim 8, wherein
the judging module is further configured to judge whether there is an obstacle not marked in the two-dimensional planar map, consider that the abnormal factor is present if there is an obstacle not marked in the two-dimensional planar map, or consider that the abnormal factor is not present if there is no obstacle not marked in the two-dimensional planar map; and
the executing module is further configured to, if there is an obstacle not marked, mark the obstacle not marked in the two-dimensional planar map according to the current depth data and the current odometer information, update the two-dimensional planar map, update the monitoring route according to the current position and the updated two-dimensional planar map, and inspect the monitored region according to the updated monitoring route.

12. The robot according to claim 8, wherein
the judging module is further configured to judge whether human skeleton data is identified, consider that the abnormal factor is present if the human skeleton data is identified, or consider that the abnormal factor is not present if the human skeleton data is not identified; and
the executing module is further configured to move towards a living body corresponding to the human skeleton data if the human skeleton data is identified; acquire a current facial feature of the living body; and match the current facial feature with a predetermined facial feature in a predetermined living body facial feature database if the current facial feature of the living body is successfully acquired, consider that the abnormal factor is not present if the matching is successful, perform a tracking operation for the living body and generating alarm information if the matching is unsuccessful.

13. The robot according to claim 12, wherein the executing module is further configured to:
acquire password information from the living body if the current facial feature of the living body is not successfully acquired; and
match the acquired password information with predetermined password information in a predetermined password database, consider that the abnormal factor is not present if the matching is successful, and perform the tracking operation for the living body and generate the alarm information if the matching is unsuccessful.

14. The robot according to claim 8, further comprising:
a smoke detecting module, configured to, in the course where the robot inspects the monitored region according to the monitoring route, acquire a current smoke concentration value if a predetermined detection time interval is reached;
wherein the judging module is further configured to judge whether the current smoke concentration value exceeds a predetermined smoke concentration threshold; and
wherein the executing module is further configured to generate alarm information if the current smoke concentration value exceeds the predetermined smoke concentration threshold, or continue to inspect the monitored region according to the monitoring route if the smoke concentration value does not exceed the predetermined smoke concentration threshold.
